(19) United States
(12) Patent Application Publication
(10) Pub. No.: US 2006/0036907 A1
(43) Pub. Date: Feb. 16, 2006

(54) Area-and product-independent test automation system and method for automatically synchronizing tests of multiple devices

(75) Inventors: Kevin Scott Inscoe, Holly Springs, NC (US); Joseph Peter Allgeyer, Gibsonville, NC (US); Roderick Eugene Parsons, Apex, NC (US); Arthur Charles Everett JR., Apex, NC (US); William Edward Daley JR., Fuquay-Varina, NC (US); Donald Bernard Hon, Fuquay-Varina, NC (US); Frank Kavanagh, Thomastown (IE)

Correspondence Address: JENKINS, WILSON & TAYLOR, P. A., 3100 TOWER BLVD, SUITE 1400, DURHAM, NC, 27707, US

(73) Assignee: EMC Corporation

(21) Appl. No.: 10/916,238

(22) Filed: Aug. 11, 2004

(51) Int. Cl. G06F 11/00

(52) U.S. Cl. 714/12

(57) ABSTRACT

An area- and product-independent test automation system and a method for synchronizing testing of multiple devices are disclosed. The test automation system may include a test sequence being written in a script language common to different products or test areas in an electronic component manufacturing or testing facility. Executable test modules control the testing of individual devices under test. The test sequence includes commands that reference the test modules. A sequencer reads the commands in the test sequence and executes the corresponding test modules. A test messaging medium receives commands from the modules and stores test status information. Device-specific controllers monitor the test messaging medium for commands and communicate with test hardware to execute the commands. The device-specific controllers also write test status information to the test messaging medium.

### TECHNICAL FIELD

The present invention relates generally to product testing. More particularly, the present invention relates to a product- and area-independent test automation system.

### BACKGROUND ART

For electronic components, such as printed circuit boards, and systems that run those components, product testing is a part of the usual factory quality control process. Despite the use of high-quality components and assembly procedures, the complex nature of electronic components subjects them to occasional manufacturing defects and failures during use. Because of the costs associated with such defects and failures in terms of manufacturer warranty obligations and end-user down time, typically a manufacturer will use product testing as a way to limit the amount of defective components leaving the factory as new or being returned to the factory as defective. Therefore, product testing is an important part of the manufacturing process.

Test Development and testing of electronic components is typically a time consuming and costly process. This testing may involve using one or more test routines wherein test data is fed to the unit under test (UUT) and the output is examined to determine if the UUT performs as expected or if there is a fault in the unit that must be isolated. In recent years, software for testing of electronic components has been developed to allow testers to perform complex test routines. Such testing includes simulation of external environmental factors, alteration of internal settings, and formatting of output results. However, even with the generation and development of complex testing software, numerous problems still exist for testing of electronic components in the manufacturing facility environment.

One such problem is that previous test systems have been generally designed for one particular area or product within a manufacturing facility or for running one particular test on the components. For example, manufacturers have conventionally developed separate software test systems for separate products or areas. Because many manufacturers produce multiple products, the development of testing systems for each of these individual products has been labor and resource intensive. Additionally, because product-specific test software is written in product-specific format, tests developed for one product or area cannot be replicated for another product or area without completely re-writing the test software.

Another problem of some previous testing systems is that test software had to be manually executed by an operator. For example, the operator may supply the software to the particular product or area by either manually executing the software on the product or in the area or by providing inputs to a testing program that determines the tests to run on the product or area. If multiple devices are being simultaneously tested, the operator must repeat the process of initiating the test for each device. Such a process is labor intensive and can increase manufacturing costs.

Based on the problems of manual testing, several attempts have been made to automate the process, usually in the form of creation of batch files or script files that specify a series of test steps to be executed by a computer. Test scripts eliminate the need for an operator to manually type in commands to be executed by a test system. However, these previous attempts at testing automation have numerous disadvantages. As discussed above, many manufacturers have teams dedicated solely to product testing where it is common for multiple operators to be testing products at the same time and for multiple computers to be used in the testing. The use of batch files alone creates complications in the management of multiple processes being conducted over multiple machines. The scalability of these previous automated testing systems has also been lacking where new software and systems have had to be developed each time products were upgraded, redesigned, or changed entirely.

Another disadvantage has been the limited user extendibility of the previous automated systems. Because previous systems were developed for one particular product or area, test operators or technicians have not been able to easily rotate between the different products and test areas, have not been able to share the different testing tools, and generally only a single user or department has been familiar with how the test system was designed or operated so that the system could not be utilized or even modified to satisfy the other department's needs. The inability to maintain proper reliability or upgrades has also plagued previous test automation systems in that since only one product or area's users were familiar with the system, any alteration of the system could not be replicated to other areas or products in the facility.

With regard to overall test tool evolution, the incorporation of graphical user interface (GUI) based enhancements to testing systems have been instrumental in making the testing process more intuitive and user-friendly. However, such enhancements have not focused on the human-operator-intensive elements of the testing process, such as reducing the need for device-specific commands and different testing systems for each test area within a facility and each device being tested.

Local area network (LAN) technology and communication architectures have also enhanced the testing of electronic component products. GUIs are conveniently located, either locally or remotely, to a particular data processing system that drives the actual testing of the electronic components. Client/server technology is utilized to provide remote access to test systems. A client application includes a GUI that allows a user to access a remote test system. A server application receives and processes requests from the client and also executes on a system in the network. The client/server framework allows a client to be located on any system in the network, even on the same system on which the server resides.

With the many varieties of products and methodologies for testing of electronic components currently available, test systems must be proficient in testing a large number of products in several different test areas and must also be able to execute the many varieties of test scripts associated with those products or areas. Thus, a test system must be capable of learning or adapting to new test case scripts and new test interfaces as required.

A test script defines how a particular test will be performed. For example, a test script may simply be a batch file containing instructions for performing a test, or a test script may be a file of commands or directives administered through a GUI. Additionally, a test script may include a data structure stored in memory that is built by a data processing system upon receipt of instructions from a client or other application. Regardless of how a test script is implemented, the test script embodies the action which will take place in order to perform a test on the unit under test.

From an operational perspective, there exists a need for the capability for users in a manufacturing environment to share test scripts and test results for multiple units under test in a shared testing environment. There also exists the need for a testing system that can execute any type of test script without knowing the specific test script formats or methodologies of each and every test script available for execution in the shared testing environment.

Additionally, there exists a long felt need for a scalable and flexible method and system for automating testing in all product and test areas in an electronic component manufacturing facility where the need for operator intervention and knowledge of device-specific test commands is minimized and the ability to synchronize similar tests for multiple units under test can be maximized.

### DISCLOSURE OF THE INVENTION

The present invention provides a universal test automation system. The system includes a test sequence language common to a plurality of different products or test areas in an electronic component manufacturing facility. The test sequence may be written in a script language format of serial command configuration. A plurality of executable test modules may control testing of units under test. The test sequence may include commands that reference the executable test modules and may include “if” statements to support conditional execution of modules. A sequencer reads the commands in the test sequence and executes the corresponding executable test modules. The executable test modules write test commands to a test messaging medium, and a plurality of device-specific controllers may monitor the test messaging medium for commands and communicate with test hardware to execute the tests.

The sequencer may include a switch parser for receiving an execution command and initiating sequencer action upon receipt of the command. The system also include a script parser for parsing and validation of the script language wherein the script language serial command is extracted and translated into parallel command format readable by the sequencer. A series of script step arrays convert the script language into script steps wherein one script step array is associated with each script step. A command interpreter steps through the script step arrays to execute each script step. A module monitor bi-directionally communicates with the test messaging medium to monitor module execution status. A script status indicator bi-directionally communicates with the test messaging medium for storing of script status information. A reporting system compiles and generates of script status report information.

The plurality of device-specific controllers of the present invention may include controllers for controlling test hardware to execute tests related to voltage margining, environmental chamber control, power cycling, vibration, or any other suitable manufacturing process.

A method for automatically synchronizing testing of a plurality of electronic units under test in a shared testing environment is also disclosed. The method may include placing first and second electronic units under test in a shared testing environment. A first test script for testing the first unit under test is executed. A second test script for testing the second unit under test is executed. When a first statement in the first test script for varying a condition of the shared testing environment, is encountered, it is determined whether a plurality of units under test are being simultaneously tested in the shared testing environment. In response to encountering the first statement and determining that a plurality of units under test are being simultaneously tested in the shared testing environment, execution of the first test script may be paused. In response to encountering the first statement in the second test script, the first statement may be executed to vary the condition in the shared testing environment. Execution of the first test script may then be resumed.

Accordingly, it is an object of the present invention to provide a universal test automation system that utilizes reusable test-script-containing modules that can be shared between multiple test areas and products within a manufacturing facility.

It is another object of the present invention to provide a universal test automation system that supports multiple units under test and supports environmental controls (power cycling, temperature, voltage margining, vibration, etc.) for testing of those units under test.

It is yet another object of the present invention to provide a universal test automation system that maintains current interfaces shop floor control systems and that has scalability limited only by hardware performance.

Some of the objects of the invention having been stated hereinabove, and which are addressed in whole or in part by the present invention, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings of which:

FIG. 1 is a block diagram illustrating an exemplary subsystem architecture for a universal test automation test system according to an embodiment of the present invention;

FIG. 2 is a block diagram illustrating an exemplary structure for a test messaging medium of a universal test automation system according to an embodiment of the present invention;

FIG. 3 is a block diagram illustrating an example of the communication interface of a universal test automation system according to an embodiment of the present invention;

FIG. 4 is a block diagram illustrating an exemplary sequencer subsystem of a universal test automation system according to an embodiment of the present invention;

FIG. 5 is a flow chart illustrating exemplary steps for automatically synchronizing testing of a plurality of electronic units under test according to an embodiment of the present invention; and

FIG. 6 is a block diagram illustrating exemplary steps for automatically synchronizing testing of a plurality of electronic units under test according to an embodiment of the present invention.

### DETAILED DESCRIPTION OF THE INVENTION

Area- and device-independent test automation systems and methods for automatically synchronizing testing of a plurality of electronic units under test (UUTs) in a shared testing environment are disclosed. The systems and methods utilize reusable modules that can be shared between multiple test areas and products and generic modules that support common hardware interfaces, such as RS-232, LAN, etc. Examples of re-usable modules are modules that create valid registry structures usable by hardware-specific controls. The systems and methods support the testing of multiple UUTs, including printed circuit boards, computer systems, and the like, that are undergoing environmental testing, such as tests related to vibration, voltage margining, temperature, and power cycling, so as to expedite failure occurrences during production testing of electronic components or as a way to isolate a given failure that has occurred to an electronic component.

The systems and methods will be explained in the context of block diagrams and flow charts. It is understood that the functionality represented by the block diagrams and flow charts can be implemented in hardware, software, firmware, or any combination thereof. Thus, the present invention can include computer program products comprising computer-executable instructions embodied in computer-readable media implementing the devices illustrated in each of the block diagrams or for performing the steps illustrated in the flow chart.

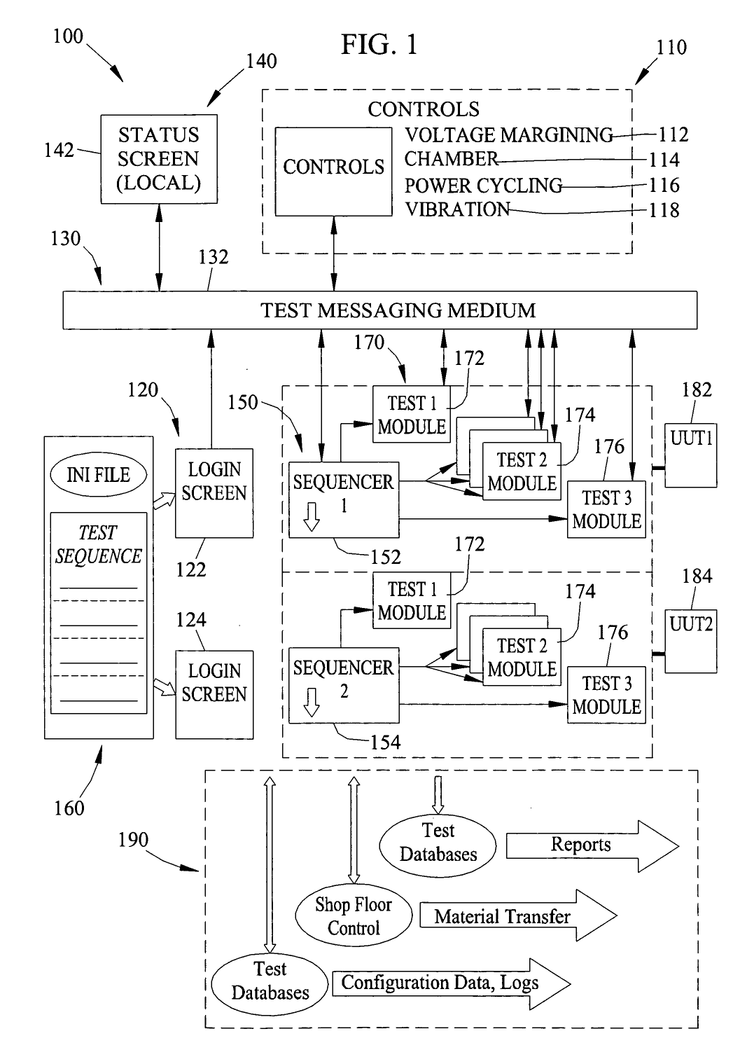

FIG. 1 illustrates a universal test automation system 100 according to an embodiment of the present invention. Universal test automation system 100 may include controls subsystem 110, login screen subsystem 120, test messaging subsystem 130, status screen 140, sequencer 150, test sequence 160, and modules subsystem 170. Units under test (UUT) 182 and 184 include electronic components that are being tested by test automation system 100. While internal communications between the various subsystems within system 100 may be performed via test messaging subsystem 130, external communications to sales order systems, test databases, file logs, etc., may be conducted via external file sharing, database queries, and report filing, shown generally as 190.

Controls subsystem 110 performs functions related to the management of external hardware required to perform specific tests being conducted on units under test 182 and 184. Controls subsystem 110 includes a plurality of device-specific controls 112, 114, 116, and 118 that monitor test messaging subsystem 130 for commands and in turn communicate those commands to test hardware to execute the indicated test. Environmental testing of units under test 182 and 184 that may be controlled through controls subsystem 110 include tests related to voltage margining (voltage margining control 112), environmental chamber control for temperature, humidity, etc. (chamber control 114), power cycling (power cycling control 116), vibration (vibration control 118), and other tests that are routinely performed on electronic components. Controls subsystem 110 communicate command and status information via test messaging subsystem 130, and controls subsystem 110 may be activated upon the boot-up of test automation system 100. While communication of command and status information from controls subsystem 110 is conducted through test messaging subsystem 130, commands to controls subsystem 110 may be issued from individual test modules 172, 174, or 176 within test modules subsystem 170 as will be described in more detail hereinbelow.

Login screen subsystem 120 is used by the test operator to introduce units under test 182 and 184 to test automation system 100. Login screen subsystem 120 may include a plurality of individual login screens 122 and 124 which may vary between different products and test areas within the manufacturing facility in order to support the variety of products and test configurations. Individual login screens 122 and 124 may be initially set up in a default status and loaded with a product's specific information and test information during the login process such as through the use of initialization or INI files. Login screens 122 and 124 may support both manual and bar code data entry methods. While individual login screens 122 and 124 may vary between product and test areas, the individual login screens preferably do not limit the number of units under test 182 and 184 that are being tested per test station. In order to enter information into login screens 122 and 124, the test operator may activate login screen subsystem 120 by clicking an icon within status screen subsystem 140 (discussed hereinbelow). Data that may be entered into login screens 122 and 124 may include sales order number, operator badge number, serial numbers, and part numbers as appropriate for the product or area being entered.

Test messaging subsystem 130 may be used to pass command and status information among the various subsystems in system 100. Test messaging system 130 may include test messaging medium 132 to which test modules and controls read and write messages in order to communicate with each other during testing. In one exemplary implementation, test messaging medium 132 may be implemented using Windows® Registry or Windows® Messaging, database interfaces, such as Microsoft® Access for communicating with outside test data, and text files for reporting to external test report files.

Status screen subsystem 140 is used to visually pass test status information to the test operator. Status screen subsystem 140 may include a plurality of status screens 142 that are located in the different test areas throughout a facility. Information displayed with the activation of status screen 142 may include product test status information such as pass, fail, time to completion of current test and the total test, and estimated time of completion (as calculated based on system configuration). Additional information displayed on status screen 142 may include the badge number or name of the last operator and the status of the specific control test being performed (power, voltage margining, temperature, vibration, etc). Status screen 142 may include one window that displays all units under test 182 and 184 and the screen may expand or contract to accommodate the number of systems or products that are being tested.

As will be described in more detail hereinbelow, sequencer subsystem 150 executes the individual modules as defined in test sequence subsystem 160. Sequencer subsystem 150 may include individual sequencers 152 and 154 related to the number of units under test 182 and 184, but unlike other subsystems within test automation system 100, product and area uniqueness is not required by sequencers 152 and 154. A single version of test sequencers 152 and 154 may be used to execute a variety of different modules. Sequencers 152 and 154 obtain module control and status information via test messaging medium 132 and generate log files or other reporting files based on information gathered from controls subsystem 110 and modules subsystem 170. Report formats may be defined by test sequence subsystem 160.

Test sequence subsystem 160 includes a list of modules to be executed by sequencer subsystem 150 for running of individual electronic component tests. Each individual product or test area may have a unique test sequence or script that defines the particular test modules that will be used and the order in which they will be executed. At the script developer's discretion, the test operator may or may not be given the opportunity to continue the testing process at a point of electronic component failure. Based upon information entered in via the login screen subsystem 120 (product to be tested, environmental test to be run, etc.), the appropriate test sequence file for the specific product or test area is loaded during the login process.

Modules subsystem 170 includes executable files that provide commands to particular units under test 182, as well as test databases, outside reporting systems, device-specific controls, etc. Modules subsystem 170 may include individual test modules 172,174 and 176 that are called by sequencers 152 and 154 as specified in test sequence subsystem 160. Examples of modules suitable for use with embodiments of the present invention include an AC power control module that connects and disconnects AC power from the unit under test and a temperature control module that allows synchronization of the test script with a chamber for environmentally stressing electronics components. Other modules may include modules that read data from and write data to the units under test.

Shop floor control reporting system 190 can be any type of reporting system specified by the manufacturing facility. Reporting system 190 may receive reports generated by test automation system 100 and may log these reports for immediate or future use in yield reporting, sales order verification, test archiving, test database files, etc. Reporting system 190 may produce output to a graphical user interface, to hard-copy print, or may store data reports on an external device. Reports produced by reporting system 190 may be used as an aid in debugging and error checking, as process control, or as a production verifier.

As described hereinabove, the interactive communication between subsystems of universal test automation system 100 may accomplished utilizing test messaging subsystem 130. Test messaging subsystem 130 10 includes test messaging medium 132 that includes various mechanisms for communication, depending on the subsystems that are attempting to communicate between one another. For example, in an embodiment of the present invention, various subsystems of test automation system 100 may be linked with test messaging medium 132 as follows:

| | | Test Messaging |
|---|---|---|
| Subsystem 1 | Subsystem 2 | Medium (132) Type |
| Sequencer | Modules | Windows ® Messaging |
| subsystem (150) | subsystem (170) | |
| Controls | Modules | Windows ® Registry |
| subsystem (110) | subsystem (170) | |
| Outside | Modules subsystem | Microsoft ® Access |
| test data | (170), Sequencer | Database |
| | subsystem (150), | |
| | Status screen | |
| | subsystem (140) | |
| Shop floor control | Test automation system | Text files |
| reporting (190) | (100) | |

Windows® Messaging is primarily used as test messaging medium 132 to monitor the status of modules 172, 174, and 176 in modules subsystem 170, that are launched by sequencer subsystem 150. The Windows® API function SendMessageTimeout is used to accomplish the task of module monitoring. Basic operation during this functioning includes: (1) the message is sent to the appropriate Windows®D address (hwnd); (2) if the message is received, the function returns with a “passing” result; and (3) if the window cannot receive the message, a “failing” result is returned. This message functionality is utilized to send various messages from modules 172, 174, and 176 within modules subsystem 170 to sequencer subsystem 150 specifying the state of the modules (ONLINE, PASS, FAIL).

In operation, with reference to test module 172, sequencer 152 of sequencer subsystem 150 may start module 172 within modules subsystem 170 upon receipt of a start command. Sequencer 152 will pass required information to any module that it starts and will then verify that the module process was successfully started. Sequencer 152 uses test messaging medium 132 (in the form of Windows® Messaging) to monitor module 172 by listening for two of three messages from module 172. Module 172 is required to send these messages at startup, on a failure, or on passing. Module 172 sends a start message within fifteen seconds of module start and sequencer 152 waits for this start message from module 172 to verify that module 172 is behaving in the desired manner. After receipt of the start message, a heartbeat is performed via Windows® Messaging at a specified interval, and if module 172 is not responding when the heartbeat is checked, a failure is reported. Sequencer 152 then waits until a pass or fail message is received from module 172 as appropriate. If module 172 fails, sequencer 152 will notify status screen 142, upon pass it will launch the next test sequence. Typical commands used through test messaging medium 132 between sequencer 152 and module 172 are as follows:

| Message | Description |
|---|---|
| ONLINE | Module 172 start verification |
| PASS | Notify of successful completion |
| FAIL | Notify of failure |

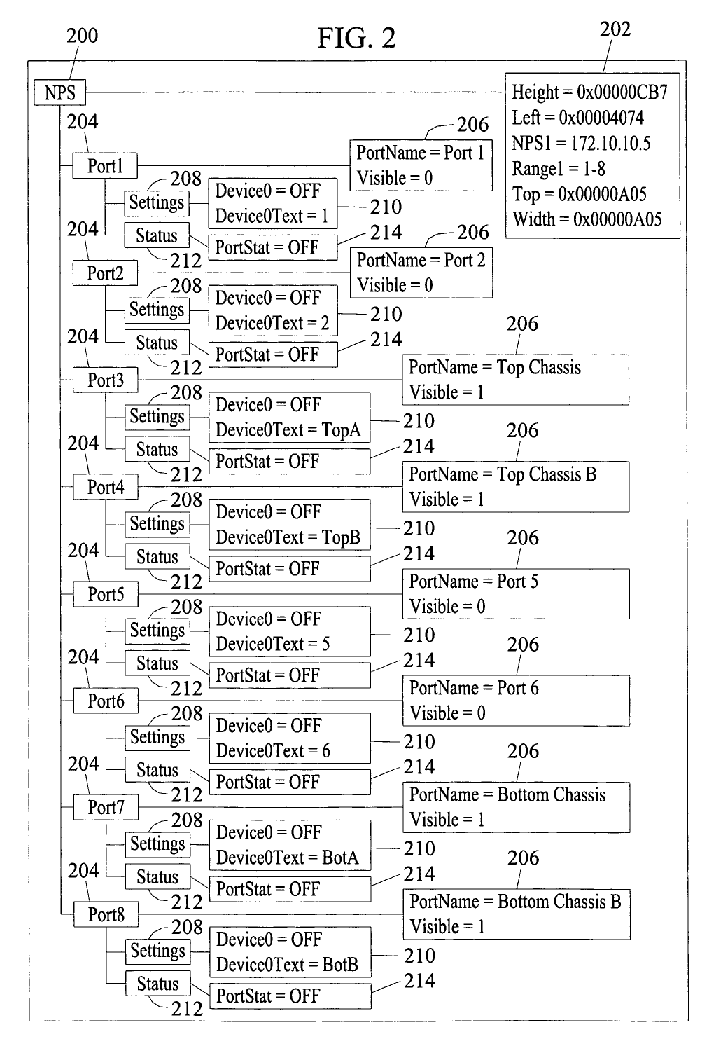

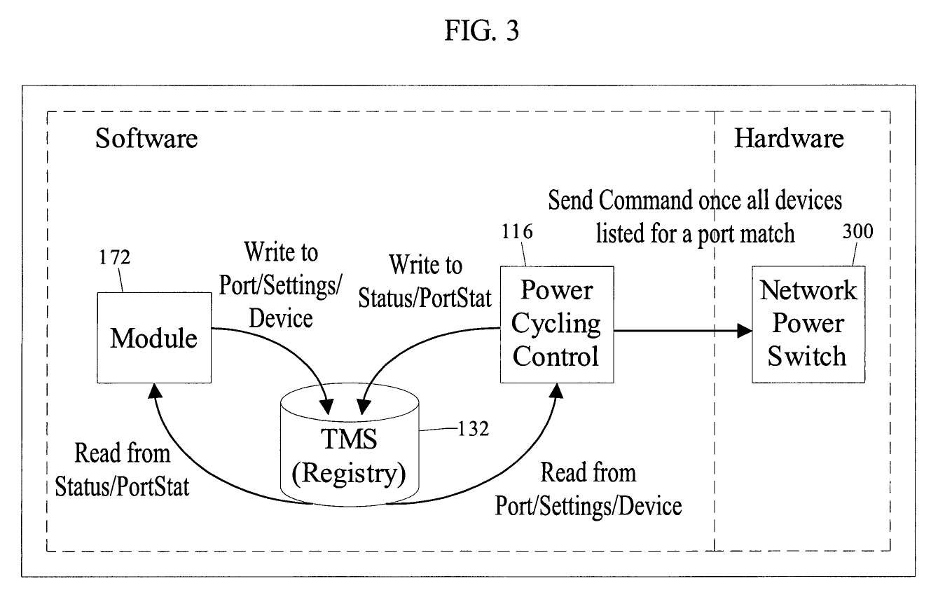

Due to the functions related to the management of external hardware that is performing tests, the plurality of device-specific controls 112, 114,116, and 118 that make up controls subsystem 110 place additional demands on communication, such as persistence of data. Due to these demands, the Windows® Registry is primarily used as test messaging medium 132 for communication between controls subsystem 110 and modules subsystem 170. The Registry stores configuration data and provides a structure that can be consistently monitored and updated. A general Registry structure is used to interface between the modules of modules subsystem 170, which are executed by sequencer subsystem 150, and controls of controls subsystem 110 that run continuously. An example of the structure of test messaging medium 132 utilizing a Registry for communication between power cycling control 116 (controlling network power switch hardware for power cycling tests) and module 172 is shown in FIG. 2 and is schematically shown in FIG. 3.

More particularly, in FIG. 2, the Windows® Registry data structure for the power cycling test comprises a tree structure that stores control and status information used in performing the power cycling test. This tree structure may be created by the network power setup module and used by the network power switch control in controlling power to a network power switch during a power cycling test. In FIG. 2, block 200 labeled NPS (network power switch) represents the directory for storing test status and control information for the power cycling test. Box 202 represents control data stored in the directory represented by block 200 for the power cycling test. More particularly, the control data includes top and left screen coordinates for display of a manual control to be used in the power cycling test, height and width data that indicate the size of the manual control, an IP address of the NPS box being utilized, and a range of port numbers assigned to the NPS box.

Blocks 204 in the Registry data structure represent directories for each port in the NPS box being utilized. Blocks 204 store information about each port, such as its name and status. In the illustrated example, each port directory 204 stores port name information 206 indicating the name of the port and whether or not the port is visible to the manual power cycling test applet. Each block 204 also includes a settings sub-directory 208 that stores settings for each port. In the illustrated example, settings 210 include a device number of command value, which indicates a device number and a command as to whether to turn the device on or off. Settings 210 also include a device name used to refer to the device.

Status sub-directories 212 store port status information 214 indicating the port status. In the illustrated example, each status sub-directory 210 indicates whether or not a port is on or off.

Thus, using the Windows® Registry structure, such as that illustrated in FIG. 2, modules can read port status information by examining the appropriate sub-directory in the registry and can change port status information by writing the appropriate values in the sub directories. Although using the Windows® Registry is one mechanism for communicating between modules and controls, the present invention is not limited to using the Windows® Registry. Any suitable data structure that is capable of storing status and control information may be used without departing from the scope of the invention.

FIG. 3 schematically illustrates communication between a power cycling test module 172 and power cycling control 116 using the Windows® Registry as test messaging medium 132. In FIG. 3, module 172 writes control information to test messaging medium 132. The control information may include any of the information illustrated in FIG. 2. Power cycling control 116 writes port status information to test messaging medium 132, such as whether a port is on or off. Power cycling control 116 reads commands from the Port/Settings/Device sub-directory in messaging medium 132. Once all devices listed for a port match hardware 300, such as a network power switch, power cycling control 116 sends the command to hardware 300. Once the command has been executed, module 172 reads port status information from the Status/PortStat sub-directory.

Returning to FIG. 1, any applicable outside test data is preferably persistent on test automation system 100 while a given unit under test 182 or 184 is logged in. Therefore, test messaging medium 132 may include a database, such as a Microsoft® Access database, for communication between the outside test data and modules subsystem 170, sequencer subsystem 150, and status screen subsystem 140. Every component of test scripts from test sequence subsystem 160, as well as runtime information, is preferably resident in this database while the applicable unit under test 182 or 184 is logged in.

One additional mechanism for communication that test messaging medium 132 may include is a text file for communication between test automation system 100 and shop floor reporting system 190. Output from test automation system 100 may be required by the manufacturer facility for reporting on system statistics on test processes, product yield, or sales orders. This information can be generated in the form of text files by test automation system 100 and then fed to shop floor reporting system 190 in any suitable format specified by the operator (i.e., screen shots, hardcopy printouts, file logs, etc.).

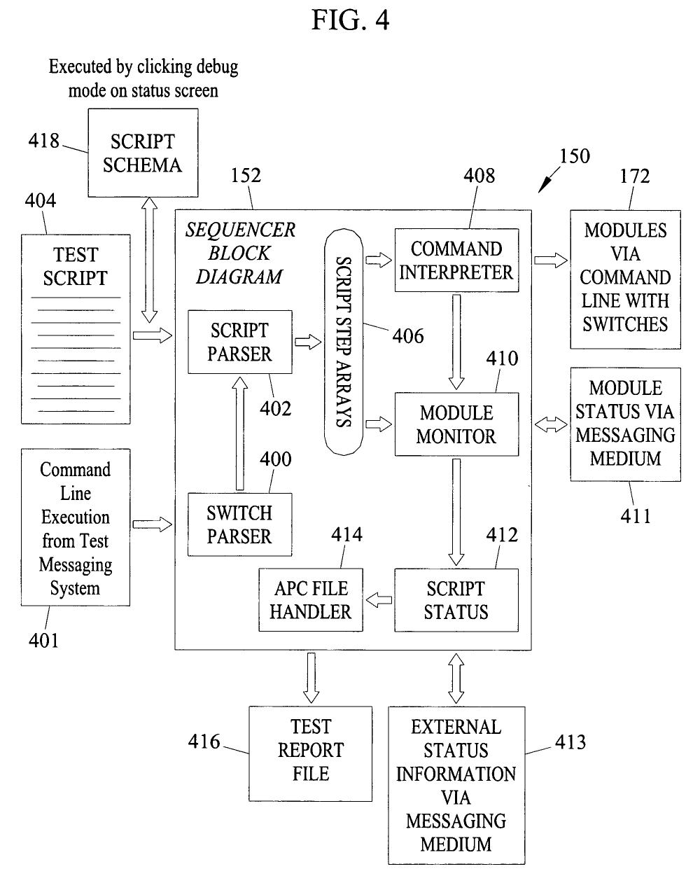

Referring now to FIG. 4, sequencer subsystem 150, with reference to individual sequencer 152, will be described in further detail. Sequencer 152 comprises various components that accept commands, communicate with individual test modules, and report information out to external reporting systems. Sequencer 152 may be activated when switch parser 400 receives a command-line command 401 from status screen subsystem 140. The command-line command may be generated automatically once information on unit under test 182 is entered into login screen 122. Switch parser 400 sets the sequencer environment in motion by generating a path for data acquisition and reporting.

Once the sequencer is started by command-line execution command 401, switch parser 400 interprets the arguments, and sequencer 152 is activated. Script parser 402 receives a test script 404 from test messaging subsystem script array table (not shown) and parses the script into test steps to be used during sequencer execution. Script parser 402 may perform validation of the script and may extract and store script fields into script step arrays 406, thereby transforming the script serial command configuration into a parallel command format. This extracting and storing by script parser 402 allows each test step in the script to be indexed using a single pointer. During the loading of the script, script parser 402 may also search the script for “time” keywords and calculated estimated “time of completion” and “time to completion” of the test run. These data values are then stored in test messaging medium 132 for later retrieval by status screen subsystem 142 for reporting display.

As discussed above, script step arrays 406 receive and store individual test steps from test script 404. Script step arrays 406 may include a series of arrays wherein one array is dedicated for each field associated with the current test step. The function of script step arrays 406 is to convert the vertical list format of the test scripts into a horizontal list that can be used by command interpreter 408, which allows the use of a single pointer to index through the script. The individual arrays of script step arrays 406 may be of data types appropriate for the respective fields within the script and may be stored in a test messaging system script array table (not shown), which can be reported to log files upon completion of the test run.

Command interpreter 408 may use an internal pointer to step through the array of script step arrays 406 in order to execute each script step. The pointer used by command interpreter 408 may will be stored in test messaging medium 132 so that the pointer can be accessed as needed by status screen subsystem 140, automatic restart functions, and for restoring default scripts when returning from a debugged mode. Command interpreter 408 may execute instructions contained in script records. When a module 172 is to be executed, the sequencer application is launched by command-line through switch parser 400, and command interpreter 408 interprets the command and determines whether to run module 172 or not, depending on conditions. If module 172 is to be run, command interpreter 408 sends a command to a module monitor 410 for execution of the module. If an abort command is received from status screen 142, the command is sent to command interpreter 408 which will immediately cease execution of test modules, script status reporting, and log generation. Upon receipt of an abort command, command interpreter 408 may shut down sequencer 152.

Module monitor 410 may access information, such as time-out values, from script step arrays 406. The purpose of module monitor 410 is to monitor start, stop, heartbeat, and error conditions 411 from individual modules 172 via messaging medium 132. This information is stored by module monitor 410 as script status 412. In order to maintain its status monitoring and reporting capabilities, module monitor 410 may have bi-directional communication with test messaging medium 132. Status information that may be maintained as script status 412 may include the total number of test steps run, the current test step number, the estimated time remaining in the test, the estimated time of completion of the test, the auto restart location, and the time required to component failure. Such status information may be reported as external status information via messaging medium 132.

File handler 414 may generate log-compliant files as needed and specified by the developer. The log files generated by file handler 414 may be exported as report files 416 and stored in log file storage 192, part of shop floor reporting system 190. Upon completion of a “successful” test run, log files stored in log file storage 192 may be zipped and archived as directed by a final module and a test sequence script.

Test automation system 100 may also include script schema 418 that allows the test engineer or technician to manually modify the execution and order of test modules. Script schema 418 may be activated by clicking an appropriate debug icon in status screen 142, thus initiating a resulting script schema process. Script schema 418 has various capabilities including enabling and disabling of modules, rearranging the execution order of modules, and looping of specific test modules. If script schema 418 is activated and the script file is reordered, script schema 418 will update login information in login screen subsystem 120 so that the new script name and the default script name and pointers are saved in test messaging system 130 and this information is communicated to applicable other subsystems.

Scripts used by test automation system 100 and fed to script parser 402 are preferably written in an area- and product-independent format. In one exemplary implementation, the format may be based on the format of an INI file and may take the following form:
[Section]—This defines a section which can contain many unique values
Value=Data—A value and data pair that serve as a unique entry in the file under any given section.

Scripts contain test sections including test steps in the order in which they are to be executed. Each line is a separate test step and is required to have at least one command line, an optfile line and a runtime. The optfile data line can be left blank, but the other fields are required to have data present. There can be more than one command and optfile lines, but there can be only one runtime. An example test step is as follows:

[STARTMSG]
CMD1=msg.exe -uut:UUT1 -file:msg.txt -msg:‘Are you ready to
start?’ -btn1:No/fail -btn2:Yes/pass
OPTFILE1=msg.txt
RUNTIME=000:00:00

In the above example, CMD1 contains the executable (module 172 for example) to run as well as any command line arguments necessary; OPTFILE1 accompanies CMD1 and specifies a file to include text from when reporting data to shop floor control reporting system 190; and RUNTIME is the overall runtime for the test step. By specifying 000:00:00, the test will not error due to time limit overrun. If a time greater than 000:00:00 was specified then the test would have to complete before that period expires to avoid a failure. By providing a product- and area-independent script language, scripts or portions of scripts written for one product or area can be re-used with another product or area.

As discussed hereinabove, module subsystem 170 includes individual test modules 172, 174, and 176 that are called by sequencers 152 and 154 to provide direct interface to particular units under test 182 and 184, test databases, device-specific controls 110, and shop floor reporting system 190. Modules 172, 174, and 176 pass status information to sequencer 152 via test messaging system 132. Test modules 172, 174, and 176 may be used to interface with units under test 182 and 184 when conducting environmental testing such as power cycling, temperature control, voltage margining, and vibration.

For example, module 172 may comprise a network power switch (NPS) module to interface with an NPS control (part of control subsystem 110) via test messaging medium 132 to provide test automation system 100 with power state changing capability for power cycling testing of unit under test 182. Such testing may be conducted using network power switch box hardware (such as Western Telematic NPS Series Network Power Switch) that is connected to a control PC via LAN protocol. The NPS control is used to communicate to any number of NPS boxes in a system via Telnet and to automated testing system 100 through test messaging medium 132 (in the form of Windows® Registry). The NPS control uses the Windows® Registry to provide status information and to control the NPS ports based on new commands and relationships between units under test 182 and 184 and power ports. Prior to the use of the NPS control to set up power control in a test cell, the NPS setup program is preferably executed to create a valid registry structure that the NPS control will use to conduct the test. Since one or more NPS power switches can be configured for use in a test environment, the NPS module allows for the assignment of one or more devices to each port (receptacle) of the power switch.

As another example, module 172 may comprise a temperature control module for chamber control 114 (part of control subsystem 110) to perform an environmental test. Such testing may be conducted using an environmental chamber connected to a control PC via RS-232. Temperature control module allows for one or more devices to share the environmental chamber.

Likewise, modules 172, 174, and 176 may also included modules for sharing system resources such as voltage margining equipment, and vibration equipment among multiple units under test. Modules 172, 174, 176 may also include modules to interface with units under test via custom or standard communication protocols such as RS-232 and LAN.

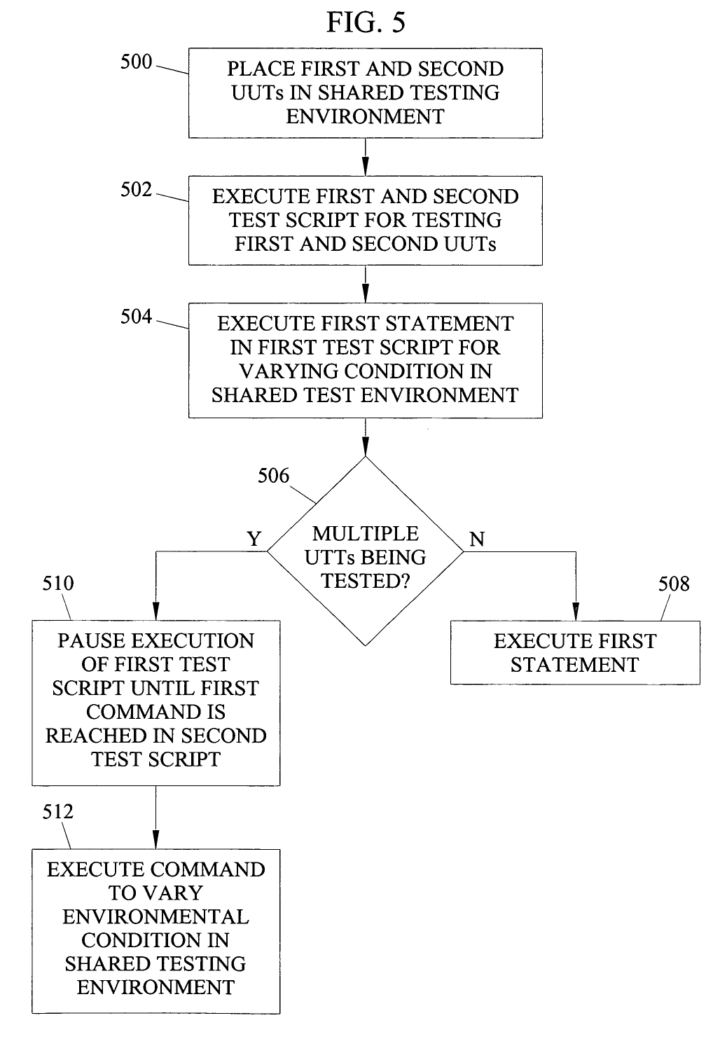

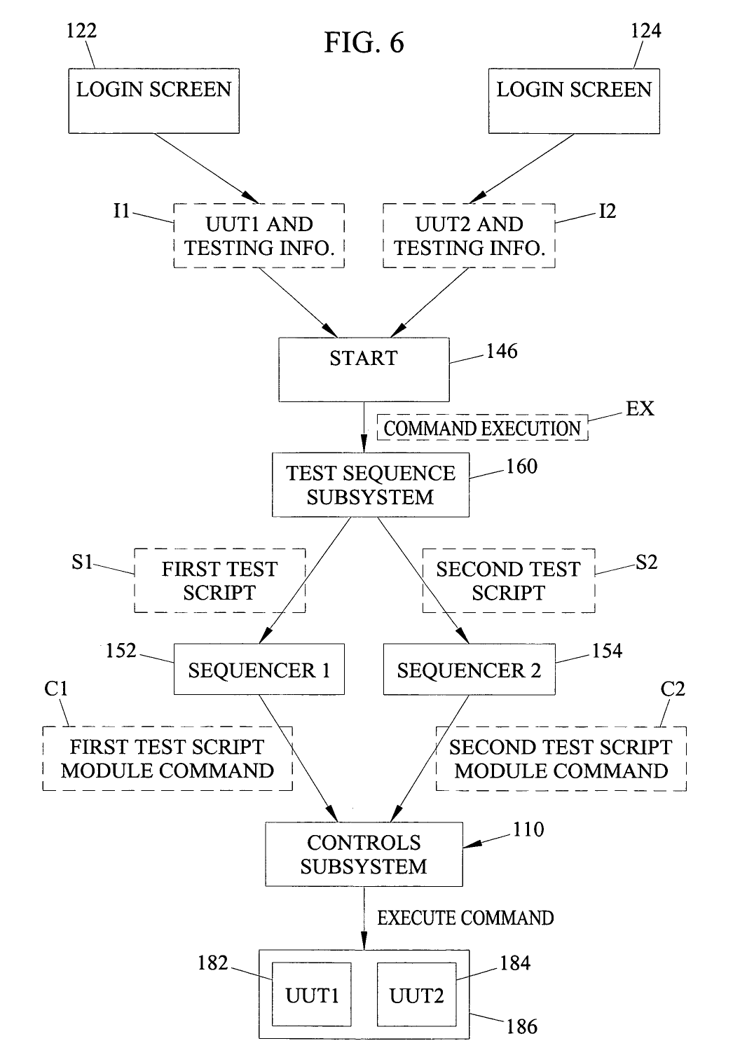

With reference to FIGS. 5 and 6, a method for automatically synchronizing testing of a plurality of electronic units under test in a shared testing environment will now be described. While the method example describes the testing of first and second units under test, it is envisioned that the test automation system of the present invention could support test synchronization for three or more units under test in a shared testing environment.

The method, for example, includes the testing of units under test 182 and 184, wherein units under test 182 and 184 are printed circuit boards undergoing board level testing in a shared testing environment of an environmental thermal test chamber 186 under conditions in which the temperature inside test chamber 186 is varied. As shown in step 500, the test operator will first place units under test 182 and 184 together within the shared testing environment of environmental test chamber 186. The operator will then introduce units under test 182 and 184 to test automation system 100 via login screens 122 and 124 on status screen 142 wherein unit and test specific information I1 and I2 is entered for the acquisition of the appropriate first and second test scripts S1 and S2 from test sequencer subsystem 160. Once unit and test information I1 and I2 regarding units under test 182 and 184 is introduced to the system via login screens 122 and 124, the operator executes test automation system 100 such as by clicking a “START” icon 146 on status screen 142.

Once the switch parsers of sequencers 152 and 154 receive the command line execution EX from status screen 142, the appropriate first and second test scripts S1 and S2 (based upon unit and test information I1 and I2 entered via login screens 122 and 124) will be received from test sequence subsystem 160. First and second test scripts S1 and S2 will be parsed and stored in arrays for execution by the command interpreters as described hereinabove. The execution of first and second test scripts S1 and S2 as shown in step 502 are required for testing units under test 182 and 184. With reference to step 504, sequencer 152 will first step through all modules 170, 172, and 174 as dictated by first test script S1 wherein, for example, a first test script module statement or command C1 in first test script S1 is encountered for varying the condition in the shared test environment (e.g., change the temperature in environment test chamber 186 from 50° C. to 30° C.). In this example, first test script module command C1 as run by sequencer 152 communicates with controls subsystem 110 to command chamber control 114 to lower the temperature in environmental test chamber 186 for temperature testing of unit under test 182.

As shown in step 506, before proceeding further, controls subsystem 110 will determine if multiple units under test are being tested. If controls subsystem 110 determines that multiple units under test are not being tested (such as if unit under test 182 is the only unit under test present in environmental test chamber 186), then an execution command will be sent by chamber control 114 to test chamber 186 to adjust the temperature as described in first test script S1 and shown as step 508. The remaining modules of first test script S1 will continue to be executed until the entire testing sequence is complete of unit under test 182.

In step 506, if controls subsystem 110 determines that multiple units under test are being tested (such as in the case where units under test 182, 184 are both present in environmental test chamber 186) then controls subsystem 110 will pause execution of first test script S1 as shown in step 510. First test script S1 will be paused until the first command is reached in the second test script (second test script module command C2) as run by sequencer 154 that calls for chamber control 114 to lower the temperature in the environmental test chamber for temperature testing of unit under test 184.

As shown as step 512, once the first command in the second test script (second test script module command C2) is reached and first test script module command C1 and second test script module command C2 are synchronized, controls subsystem 110 will cease pausing of the first test script and will execute the command to environmental test chamber 186 to lower the temperature as dictated in the first and second test scripts S1 and S2.

A similar method example can be shown with regards to a chassis level test involving chassis memory testing. In this example, the test area may comprise one or more chasses that are undergoing memory testing wherein if one chassis is being tested and has completed its memory test, typically a signal is sent to power down the cabinet that contains the chassis. However, if an operator is testing two or more chasses in the cabinet, the operator would not want the cabinet to power down until memory testing is completed for all chasses undergoing testing.

Therefore, a method for synchronizing chassis-level memory tests according to an embodiment of the present invention would include placing first and second units under test 182 and 184 (consisting of two chasses) in a cabinet 186 for memory testing. The operator may enter information I1 and I2 on both units under test 182 and 184 into login screens 122 and 124 so as to introduce units under test 182 and 184 to test automation system 100. The operator may initiate the execution of the system and upon receipt of the command line execution, sequencers 152 and 154 would execute first and second test scripts SI and S2 for testing units under test 182 and 184. Once sequencer 152 has stepped through all test modules related to memory testing on unit under test 182 (those not requiring synchronization with sequencer 154), controls subsystem 110 would receive a command from sequencer 152 to power down cabinet 186.

Recognizing that this command in first test script S1 may require synchronization with other test scripts for multiple units under test, control subsystem 110 may then determine if multiple units under test are being tested. If not, the command to power down cabinet 186 would be issued and cabinet 186 would be powered down. However, if multiple units under test are indicated, control subsystem 110 may pause execution of first test script S1 until a similar command within second test script S2 (being run by sequencer 154) for powering down cabinet 186 is received. Once that command for powering down cabinet 186 from second test script S2 is received and synched by control subsystem 110, the command to power down cabinet 186 would be issued and cabinet 186 would be powered down.

Similar methods could be conducted by test automation system 100 for the testing of various products or in various areas throughout a manufacturing facility from board level testing up to system level testing.

Thus, the present invention includes a product- and area-independent test automation system and a method for synchronizing tests of multiple devices in a shared testing environment. The methods and systems described herein greatly decrease the time required to modify and develop new tests because test sequences can be written in product- and area-independent script language. The time for executing tests in different areas is further reduced by modules that can be re-used to test different products in different areas. In addition, manual synchronization of multiple products under test is not required as the control subsystem described herein automatically performs such synchronization.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A universal test automation system, the system comprising:
(a) a test sequence being written in a script language common to a plurality of different products or test areas in an electronic component manufacturing or testing facility;
(b) a plurality of executable test modules for controlling testing of units under test, wherein the test sequence includes commands that reference the executable test modules;
(c) a sequencer for reading the commands in the test sequence and executing the corresponding executable test modules;
(d) a test messaging medium for receiving commands from the test messaging modules and for storing test status information; and
(e) a plurality of device-specific controllers for monitoring the test messaging medium for commands, for communicating with test hardware to execute the commands, and for writing the test status information to the test messaging medium.

2. The test automation system of claim 1 wherein the plurality of executable test modules includes at least one module that is re-usable to test different units under test.

3. The test automation system of claim 1 wherein the plurality of executable test modules includes at least one module for implementing a communications interface.

4. The test automation system of claim 1 wherein the sequencer comprises:
(a) a switch parser for receiving a command execution and initiating sequencer action upon receipt of the command execution;
(b) a script parser for parsing and validation of the script language wherein the script language serial command is extracted and translated into parallel command format readable by the sequencer;
(c) a plurality of script step arrays for converting the script language into script steps wherein one script step array is associated with each script step;
(d) a command interpreter for stepping through the script step arrays to execute each script step;
(e) a module monitor operatively associated with the test messaging medium for monitoring and storing the test status information; and
(f) a reporting system for compilation and generation of reports based on the script status information.

5. The test automation system of claim, 1 wherein the test messaging medium comprises a registry.

6. The test automation system of claim 1 wherein the test messaging medium comprises a Windows® messaging system.

7. The test automation system of claim 1 wherein the test messaging medium comprises a database.

8. The test automation system of claim 1 wherein the test messaging medium comprises a text file.

9. The test automation system of claim 1 wherein the plurality of device-specific controllers includes a controller for controlling test hardware executing tests related to voltage margining.

10. The test automation system of claim 1 wherein the plurality of device-specific controllers includes a controller for controlling test hardware executing tests related to environmental chamber control.

11. The test automation system of claim 1 wherein the plurality of device-specific controllers includes a controller for controlling test hardware executing tests related to power cycling.

12. The test automation system of claim 1 wherein the plurality of device-specific controllers includes a controller for controlling test hardware executing tests related to vibration.

13. The test automation system of claim 1 further comprising a user interface for initiating the execution of the test sequence and displaying subsequent test results.

14. The test automation system of claim 13 wherein the user interface comprises a graphical user interface.

15. The test automation system of claim 13 wherein the user interface comprises a plurality of login screens associated with the plurality of different products or areas and configured to introduce the units under test to the test automation system through entry of data.

16. The test automation system of claim 15 wherein at least one of the plurality of login screens supports manual data entry methods.

17. The test automation system of claim 15 wherein at least one of the plurality of login screens supports bar code data entry methods.

18. The test automation system of claim 15 wherein data entered into at least one of the plurality of login screens are sales order numbers, operator badge numbers, serial numbers, or part numbers.

19. The test automation system of claim 1 wherein the units under test comprise printed circuit boards.

20. The test automation system of claim 1 wherein the units under test comprise computer systems.

21. The test automation system of claim 1 wherein the units under test comprise computer peripherals.

22. A universal test automation system comprising:
(a) a sequencer for receiving test scripts and for executing commands specified by the test scripts;
(b) a plurality of executable test module files for implementing specific tests, wherein the sequence executes the test modules specified by the test scripts; and
(c) a plurality of hardware-specific controllers for interfacing with test hardware for testing the units under test.

23. A method for automatically synchronizing testing of a plurality of electronic units under test in a shared testing environment comprising:
(a) placing first and second electronic units under test in a shared testing environment;
(b) executing a first test script for testing the first unit under test;
(c) executing a second test script for testing the second unit under test;
(d) encountering a first statement in the first test script for varying a condition of the shared testing environment;
(e) determining whether a plurality of units under test are being simultaneously tested in the shared testing environment;
(f) in response to encountering the first statement and determining that a plurality of units under test are being simultaneously tested in the shared testing environment, pausing execution of the first test script; and
(g) in response to encountering the first statement in the second test script, executing the first statement to vary the condition in the shared testing environment and resuming execution of the first test script.

24. The method of claim 23 wherein the first and second test scripts each implement a voltage margining test for the electronic units under test.

25. The method of claim 23 wherein the first and second test scripts each implement an environmental chamber control test for the electronic units under test.

26. The method of claim 23 wherein the first and second test scripts each implement a power cycling test for the electronic units under test.

27. The method of claim 23 wherein the first and second test scripts each implement a vibration test for the electronic units under test.

28. The method of claim 23 wherein the electronic units under test comprise printed circuit boards.

29. The method of claim 23 wherein the electronic units under test comprise computer systems.

30. The method of claim 23 wherein the electronic units under test comprise computer peripherals.
